(19) United States
(12) Patent Application Publication
(10) Pub. No.: US 2017/0311242 A1
(43) Pub. Date: Oct. 26, 2017

(54) TECHNIQUES FOR CALL FUSION WITH MULTIPLE NETWORKS

(71) Applicant: QUALCOMM Incorporated, San Diego, CA (US)

(72) Inventors: Anand Krishna Puranik, Hyderabad (IN); Raghavendra Shyam Ananda LNU, Hyderabad (IN); Anand Rajurkar, Hyderabad (IN)

(21) Appl. No.: 15/133,628

(22) Filed: Apr. 20, 2016

(51) Int. Cl. H04W 48/18; H04W 68/00; H04M 1/663; H04M 3/42; H04M 3/02; H04W 4/16; H04W 24/02; H04W 84/12

(52) U.S. Cl. CPC H04W 48/18; H04W 4/16; H04W 68/005; H04W 24/02; H04M 1/663; H04M 3/42059; H04M 3/02; H04W 84/12

(57) ABSTRACT

Methods, systems, and devices for wireless communication are described. Mobile devices, such as a user equipment (UE), may be able to communicate over a number of different networks, such as a WWAN and a WLAN. Similarly, the UE may be able to perform calls using a number of different networks. At times, completing a call using a WWAN may be preferable to using a WLAN, and at other times completing a call using a WLAN may be preferable to using a WWAN. As such, a UE may receive a plurality of calls, may determine that the calls originate from a same user, may determine which network to select for completing the call, and may complete the call using the selected network. Similarly, a UE may share a vocoder and/or other call components between WWAN components and WLAN components to enable simultaneous initiation of calls on different networks.

### BACKGROUND

The following relates generally to wireless communication, and more specifically to call fusion with multiple networks.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may each be referred to as a user equipment (UE). A wireless network may also include components of a wireless local area network (WLAN), such as a Wi-Fi (i.e., IEEE 802.11) network, and may include access points (APs) that may communicate with at least one UE or station (STA).

UEs which can communicate on multiple networks may be able to perform calls on a number of the networks. In some cases, one network may be preferred for calls over another network. For example, it may be preferred to perform calls using a WLAN because WLAN calls may be free to a user, while calls performed using a wireless wide area network (WWAN) may require a subscription or other fees to perform the call. In contrast, calls performed using a WWAN may have reduced call establishment delays, less link latency, or higher link quality when compared to calls performed using WLAN. However, a user may not be aware of current link conditions when originating a call. As a result, a user may select a network to complete a call which is less than ideal, such as based on a cost of the call, a link latency, a link quality, or other factors.

### SUMMARY

The described techniques relate to improved methods, systems, devices, or apparatuses that support call fusion with multiple networks. Generally, the described techniques provide for simultaneous origination of calls over a plurality of networks. A network component may evaluate conditions, such as link conditions, while the call is ringing. The network component may then select one of the networks on which to complete the call, before completing the connection on the selected network.

A method of wireless communication is described. The method may include receiving a first message to originate a first call on a first network, receiving a second message to originate a second call on a second network, determining that the first call and the second call originate from a same user and selecting the first network or the second network to complete a connection for a call.

An apparatus for wireless communication is described. The apparatus may include means for receiving a first message to originate a first call on a first network, means for receiving a second message to originate a second call on a second network, means for determining that the first call and the second call originate from a same user and means for selecting the first network or the second network to complete a connection for a call.

A further apparatus is described. The apparatus may include a processor, memory in electronic communication with the processor, and instructions stored in the memory. The instructions may be operable to cause the processor to receive a first message to originate a first call on a first network, receive a second message to originate a second call on a second network, determine that the first call and the second call originate from a same user and select the first network or the second network to complete a connection for a call.

A further apparatus is described. The apparatus may include a receiver to receive a first message to originate a first call on a first network and to receive a second message to originate a second call on a second network, a caller identification component to determine that the first call and the second call originate from a same user, and a network selection component to select the first network or the second network to complete a connection for a call.

A non-transitory computer readable medium for wireless communication is described. The non-transitory computer-readable medium may include instructions to cause a processor to receive a first message to originate a first call on a first network, receive a second message to originate a second call on a second network, determine that the first call and the second call originate from a same user and select the first network or the second network to complete a connection for a call.

In some examples of the method, apparatus, or non-transitory computer-readable medium described above, selecting the first network or the second network comprises: selecting the second network to complete the connection for the second call based on a link latency, a link quality, or a combination thereof. In some examples of the method, apparatus, or non-transitory computer-readable medium described above, the first network is a wireless wide area network (WWAN) and the second network is a wireless local area network (WLAN).

Some examples of the method, apparatus, or non-transitory computer-readable medium described above may further include processes, features, means, or instructions for transmitting a page response responsive to the first initiation. Some examples of the method, apparatus, or non-transitory computer-readable medium described above may further include processes, features, means, or instructions for transmitting a ringing response responsive to the second initiation.

In some examples of the method, apparatus, or non-transitory computer-readable medium described above, determining that the first call and the second call originate from the same user comprises: matching a caller identification (ID) on the first network with server data relating to the same user from the second network.

Some examples of the method, apparatus, or non-transitory computer-readable medium described above may further include processes, features, means, or instructions for selecting the first network or the second network is performed based on determining that a switching criteria has been fulfilled.

Some examples of the method, apparatus, or non-transitory computer-readable medium described above may further include processes, features, means, or instructions for rejecting the first call or the second call on the first network or the second network based on selecting the first network or the second network to complete the connection.

In some examples of the method, apparatus, or non-transitory computer-readable medium described above, selecting the first network or the second network comprises: selecting the first network to complete the connection for the first call based on determining that the second network is unreliable based on a current location, a user history, or a combination thereof.

A method of wireless communication is described. The method may include simultaneously initiating a first call and a second call, transmitting a first message to originate the first call on a first network, transmitting a second message to originate the second call on a second network and establishing a connection for a call on the first network or the second network.

An apparatus for wireless communication is described. The apparatus may include means for simultaneously initiating a first call and a second call, means for transmitting a first message to originate the first call on a first network, means for transmitting a second message to originate the second call on a second network and means for establishing a connection for a call on the first network or the second network.

A further apparatus is described. The apparatus may include a processor, memory in electronic communication with the processor, and instructions stored in the memory. The instructions may be operable to cause the processor to simultaneously initiate a first call and a second call, transmit a first message to originate the first call on a first network, transmit a second message to originate the second call on a second network and establish a connection for a call on the first network or the second network.

A non-transitory computer readable medium for wireless communication is described. The non-transitory computer-readable medium may include instructions to cause a processor to simultaneously initiate a first call and a second call, transmit a first message to originate the first call on a first network, transmit a second message to originate the second call on a second network and establish a connection for a call on the first network or the second network.

In some examples of the method, apparatus, or non-transitory computer-readable medium described above, the first call and the second call are initiated simultaneously by a same vocoder. In some examples of the method, apparatus, or non-transitory computer-readable medium described above, the first network and the second network are different networks.

In some examples of the method, apparatus, or non-transitory computer-readable medium described above, the first network is a wireless wide area network (WWAN) and the second network is a wireless local area network (WLAN).

Some examples of the method, apparatus, or non-transitory computer-readable medium described above may further include processes, features, means, or instructions for receiving a page response responsive to the first message. Some examples of the method, apparatus, or non-transitory computer-readable medium described above may further include processes, features, means, or instructions for receiving a ringing response responsive to the second message.

In some examples of the method, apparatus, or non-transitory computer-readable medium described above, the first message and the second message are transmitted to a same user. Some examples of the method, apparatus, or non-transitory computer-readable medium described above may further include processes, features, means, or instructions for determining that the same user is present on at least one of the first network or the second network.

Some examples of the method, apparatus, or non-transitory computer-readable medium described above may further include processes, features, means, or instructions for transmitting first network identification information on the first network, where the first network identification information identifies at least a source of the first call. Some examples of the method, apparatus, or non-transitory computer-readable medium described above may further include processes, features, means, or instructions for transmitting second network identification information on the second network, where the second network identification information identifies at least the source of the second call.

In some examples of the method, apparatus, or non-transitory computer-readable medium described above, establishing the connection comprises: receiving a network indicator, where the network indicator indicates a network to use for establishing the connection. Some examples of the method, apparatus, or non-transitory computer-readable medium described above may further include processes, features, means, or instructions for selecting the first network or the second network to complete the connection for the first call or the second call based on the network indicator.

### BRIEF DESCRIPTION OF THE DRAWINGS

FIG. 1 illustrates an example of a wireless communications system that supports call fusion in accordance with aspects of the present disclosure;

FIG. 2 illustrates an example of a wireless communications system that supports call fusion in accordance with aspects of the present disclosure;

FIG. 3 illustrates an example of a process flow in a system that supports call fusion in accordance with aspects of the present disclosure;

FIG. 4 illustrates a block diagram of a wireless device that supports call fusion in accordance with aspects of the present disclosure;

FIGS. 5 through 7 show block diagrams of a wireless device that supports call fusion in accordance with aspects of the present disclosure;

FIG. 8 illustrates a block diagram of a system including a UE that supports call fusion in accordance with aspects of the present disclosure; and

FIGS. 9 through 12 illustrate methods for call fusion in accordance with aspects of the present disclosure.

### DETAILED DESCRIPTION

In a wireless communications network, multiple network technologies may be implemented simultaneously. Some user equipment (UEs), or stations (STAs), may be capable of communicating using a plurality of the networks. Similarly, some UEs may be capable of performing calls using any one of the plurality of networks. Different networks may be preferred for performing calls in various situations. For example, a wireless local area network (WLAN) may be a preferred due to a reduced cost of performing a call over a WLAN compared to over a wireless wide area network (WWAN). In some cases, a WWAN network may be preferable for performing a call due to a lower link latency, a higher link quality, or knowledge that a WLAN is unreliable. As such, it is desired to initiate a call on multiple networks, such as a WWAN and a WLAN, while evaluating which network to select for completing the call, before completing the connection using the selected network. Specifically, a network component, such as a UE, may receive a first message to originate a first call on a first network. The UE may also receive a second message to originate a second call on a second network. The UE may determine that the first call and the second call originate from a same user, and the UE may select the first network or the second network to complete a connection for a call.

Aspects of the disclosure are initially described in the context of a wireless communication system. A process flow is further used to describe aspects of call fusion with multiple networks. Aspects of the disclosure are further illustrated by and described with reference to apparatus diagrams, system diagrams, and flowcharts that relate to call fusion with multiple networks.

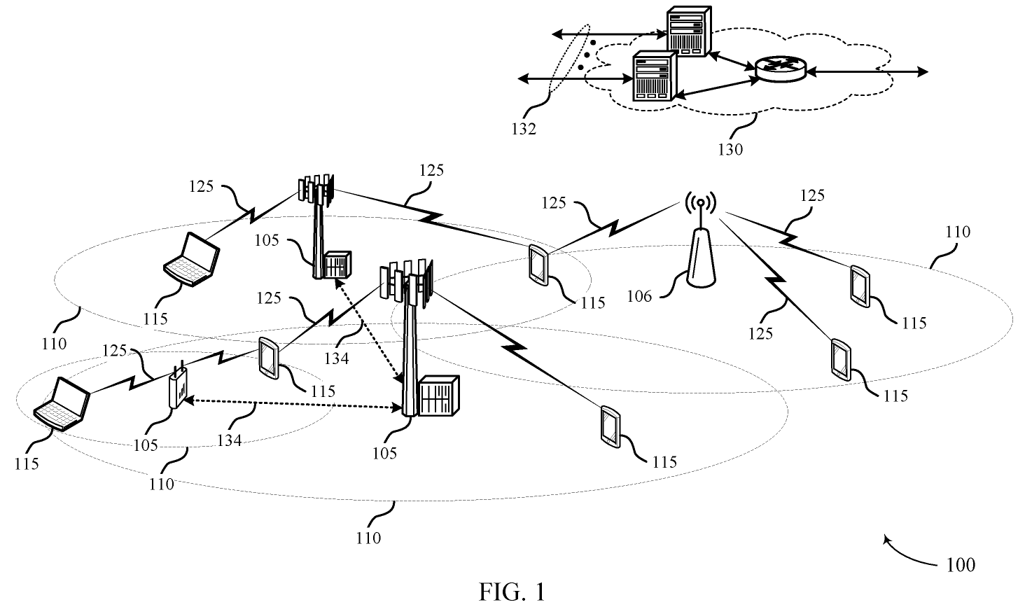

FIG. 1 illustrates an example of a wireless communications system 100 in accordance with various aspects of the present disclosure. The wireless communications system 100 includes base stations 105, access points (APs) 106, UEs 115, and a core network 130. In some examples, the wireless communications system 100 may be a Long Term Evolution (LTE)/LTE-Advanced (LTE-A) network. In some cases, at least the base stations 105, APs 106, and UEs 115 may facilitate connecting UEs for calls, such as voice calls, video calls, and the like. Further, a call between a number of UEs may be originated using a number of networks and a decision may be made as to which network is preferable for completing the connection for the call.

Base stations 105 may wirelessly communicate with UEs 115 via at least one base station antenna. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a station (STA), a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, a machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

The wireless communications system 100 may also include at least one access point (AP) 106, which may communicate with UEs 115 such as mobile stations, personal digital assistant (PDAs), other handheld devices, netbooks, notebook computers, tablet computers, laptops, display devices (e.g., TVs, computer monitors, etc.), printers, etc. In some cases, the AP 106 may be a component of a WLAN, which may be a trusted WLAN associated with the WWAN of wireless communications system 100. The AP 106 and the associated UEs 115 may represent a basic service set (BSS) or an extended service set (ESS). The various UEs 115 in the network are able to communicate with one another through the AP 106. Also shown is a coverage area 110 of the AP 106, which may represent a basic service area (BSA) of the wireless communications system 100. An extended network station (not shown) associated with the wireless communications system 100 may be connected to a wired or wireless distribution system that may allow multiple APs 106 to be connected in an ESS. In some cases, an AP 106 and a base station 105 may be collocated.

Although not shown in FIG. 1, a UE 115 may be located in the intersection of more than one coverage area 110 and may associate with more than one base station 105 or AP 106. A single AP 106 and an associated set of UEs 115 may be referred to as a BSS. An ESS can be a set of connected BSSs. A distribution system (not shown) may be used to connect APs 106 in an ESS. In some cases, the coverage area 110 of an AP 106 may be divided into sectors (also not shown). The wireless communications system 100 may include APs 106 of different types (e.g., metropolitan area, home network, etc.), with varying and overlapping coverage areas 110. Two UEs 115 may also communicate directly via a direct wireless link 125 regardless of whether both UEs 115 are in the same coverage area 110. Examples of direct wireless links 120 may include Wi-Fi Direct connections, Wi-Fi Tunneled

Direct Link Setup (TDLS) links, and other group connections. UEs 115 and APs 106 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within wireless communications system 100.

In some cases, a UE 115, AP 106, or base station 105 may operate in a shared or unlicensed frequency spectrum. These devices may perform a clear channel assessment (CCA) prior to communicating to determine whether the channel is available. A CCA may include an energy detection procedure to determine whether there are any other active transmissions. For example, the device may infer that a change in a received signal strength indication (RSSI) of a power meter indicates that a channel is occupied. Specifically, signal power that is concentrated in a certain bandwidth and exceeds a predetermined noise floor may indicate another wireless transmitter. A CCA may also include detection of specific sequences that indicate use of the channel. For example, another device may transmit a specific preamble prior to transmitting a data sequence.

In some cases, a UE 115 may enter an idle mode and periodically wake up to receive paging messages. In some cases, a UE 115 in idle mode may be assigned a paging radio network temporary identity (P-RNTI). If the serving gateway (S-GW) receives data for the UE 115, it may notify the mobility management entity (MME), which may send a paging message to every base station 105 within an area known as a tracking area. Each base station 105 within the tracking area may send a paging message with the P-RNTI. Thus, the UE may remain in idle without updating the MME until it leaves the tracking area.

In some cases, wireless communications system 100 may utilize at least one enhanced component carrier (eCC). An eCC may be characterized by at least one feature including: flexible bandwidth, different transmission time intervals (TTIs), and modified control channel configuration. In some cases, an eCC may be associated with a carrier aggregation (CA) configuration or a dual connectivity configuration (e.g., when multiple serving cells have a suboptimal backhaul link). An eCC may also be configured for use in unlicensed spectrum or shared spectrum (e.g., where more than one operator is licensed to use the spectrum).

An eCC characterized by flexible bandwidth may include at least one segment that may be utilized by UEs 115 that are not capable of monitoring the whole bandwidth or prefer to use a limited bandwidth (e.g., to conserve power). In some cases, an eCC may utilize a different TTI length than other component carriers (CCs), which may include use of a reduced or variable symbol duration as compared with TTIs of the other CCs. The symbol duration may remain the same, in some cases, but each symbol may represent a distinct TTI. In some examples, an eCC may support transmissions using different TTI lengths. For example, some CCs may use uniform 1 ms TTIs, whereas an eCC may use a TTI length of a single symbol, a pair of symbols, or a slot. In some cases, a shorter symbol duration may also be associated with increased subcarrier spacing. In conjunction with the reduced TTI length, an eCC may utilize dynamic time division duplex (TDD) operation (i.e., it may switch from DL to UL operation for short bursts according to dynamic conditions.)

Flexible bandwidth and variable TTIs may be associated with a modified control channel configuration (e.g., an eCC may utilize an enhanced physical downlink control channel (ePDCCH) for DL control information). For example, at least one control channel of an eCC may utilize frequency-division multiplexing (FDM) scheduling to accommodate flexible bandwidth use. Other control channel modifications include the use of additional control channels (e.g., for evolved multimedia broadcast multicast service (eMBMS) scheduling, or to indicate the length of variable length UL and DL bursts), or control channels transmitted at different intervals. An eCC may also include modified or additional hybrid automatic repeat request (HARM) related control information.

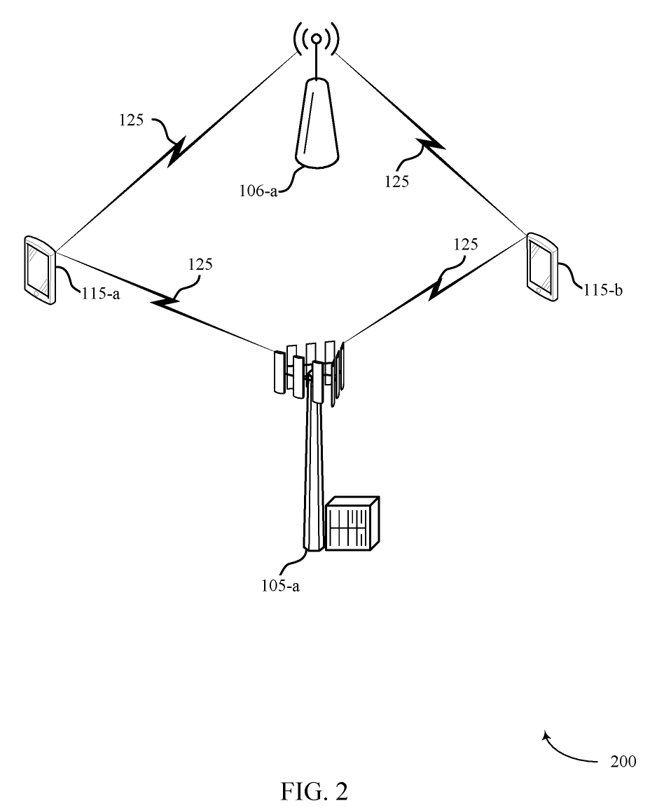

FIG. 2 illustrates an example of a wireless communications system 200 for call fusion. Wireless communications system 200 may include base station 105-a, access point 106-a, UE 115-a, and UE 115-b, which may be examples of the corresponding devices described with reference to FIG. 1. The examples described below with reference to a UE 115 may be performed by any number of devices, such as a base station 105, an AP 106, or a core network 130. Similarly, the examples described below with reference to a base station 105 or an AP 106 may be performed by any number of devices, such as a core network 130 or a UE 115. Wireless communications system 200 may implement call fusion with multiple networks.

In some cases, the base station 105-a is associated with a first network, such as a WWAN network. The AP 106-a may be associated with a second network, such as a WLAN network. The first network and the second network may be the same or different networks. In some cases, the first network is a different, or a same, radio access technology (RAT) compared to the second network. The UEs 115 may communicate with the base station 105-a and/or the AP 106-a using wireless link 125, as described above for FIG. 1. For example, UE 115-a or UE 115-b may exchange a number of messages, using wireless links 125, with base station 105-a or AP 106-a to originate a call, such as a voice call, a video call, etc.

Calls, such as voice calls or video calls, may be connected or established using a variety of networks. For example, a voice call may be connected using a WWAN or using a WLAN. In different situations, it may be preferable to use one network over another. WWANs may be desired due to a low latency or minimal delays. WLANs may be desired to reduce WWAN traffic, as traffic which otherwise might use the WWAN may be redirected to the WLAN, allowing other traffic without the capability to leverage the bandwidth of WLAN to remain on a less congested WWAN. Further, WLAN networks are often cheaper to use than WWAN networks, and a user may save money by directing a call through WLAN rather than WWAN. The wireless communications network 200 enables a UE to originate a call using both a first network, such as a WWAN network, and a second network, such as a WLAN network. Further, the wireless communications network 200 allows a network entity, such as UE 115-b, to receive a message or indication, or determine, that calls are available on a number of networks and determine which network to use for completing the call. At times, the available calls on the number of networks originate from the same UE, such as UE 115-a.

In wireless communications system 200, a transmitting UE, such as UE 115-a, may transmit a first message to originate a first call on a first network. In some cases, the first network is a WWAN. The first message may be transmitted directly to a UE, such as UE 115-b, or may be routed through other network entities, such as base station 105-a, before arriving at the receiving UE 115-b. The transmitting UE 115-a may transmit a second message to originate a second call on a second network. The second network may be a WLAN. The second message may be transmitted directly to UE 115-b, or may be routed through other network entities, such as access point 106-a, before arriving at the receiving UE 115-b. In some cases, the first call and the second call may be originated at similar times, such as simultaneously, or sequentially. It may be desirable to originate the calls on the different networks at approximately the same time, or with as little time between the call originations as possible. By minimizing the time between call originations it may reduce potential delays associated with determining which network to use for connecting the call, thereby reducing impact to the end user. Resources used to originate a call may be multiplexed so that calls using multiple different networks may be originated simultaneously. As such, the originations may not happen at the same exact instant of time, but would be occurring simultaneously based on the multiplexed resources.

The receiving UE 115-b may receive the first message and the second message on the first network and the second network respectively. The first message and the second message may be received from the base station 105-a and the AP 106-a, respectively, from the transmitting UE 115-a, or from another network component. The receiving UE 115-b may determine whether the calls on the different networks originate from the same user, or from the same transmitting UE 115-a. The receiving UE 115-b, or another network component, may determine which network to use for completing the call based on a number of factors.

For example, the receiving UE 115-b, or another network component, may determine a preferred network, such as the first network or the second network, based on a link latency, a link quality, an unreliability or user history, a current location of the receiving UE 115-b, or any combination thereof. In some cases, a network may be a preferred network by default, and will be the selected network unless a threshold is met. For example, to reduce cost to the user, the WLAN may be the preferred network and may be selected to complete the connection unless a link latency or a link quality are below a threshold value for link latency and link quality respectively, in which case the WWAN may be selected to complete the call.

Once a network is selected for completing the connection, the receiving UE 115-b may optionally reject calls on networks not selected for completing the connection. Once the network is selected for completing the connection, the receiving UE 115-b may use the selected network to complete the connection and establish a call with the transmitting UE 115-a. For the purposes of the present disclosure, call fusion refers to originating multiple calls at a transmitting UE, receiving an indication that multiple calls from the same user are available at the receiving UE, selecting one of the calls to connect, and establishing a call by connecting one of the plurality of calls. In other words, call fusion may refer to a single UE attempting to establish a call with a different UE by originating a plurality of calls to the different UE, at times using different networks, before connecting one of the plurality of calls, thereby fusing the plurality of calls into a single connected call.

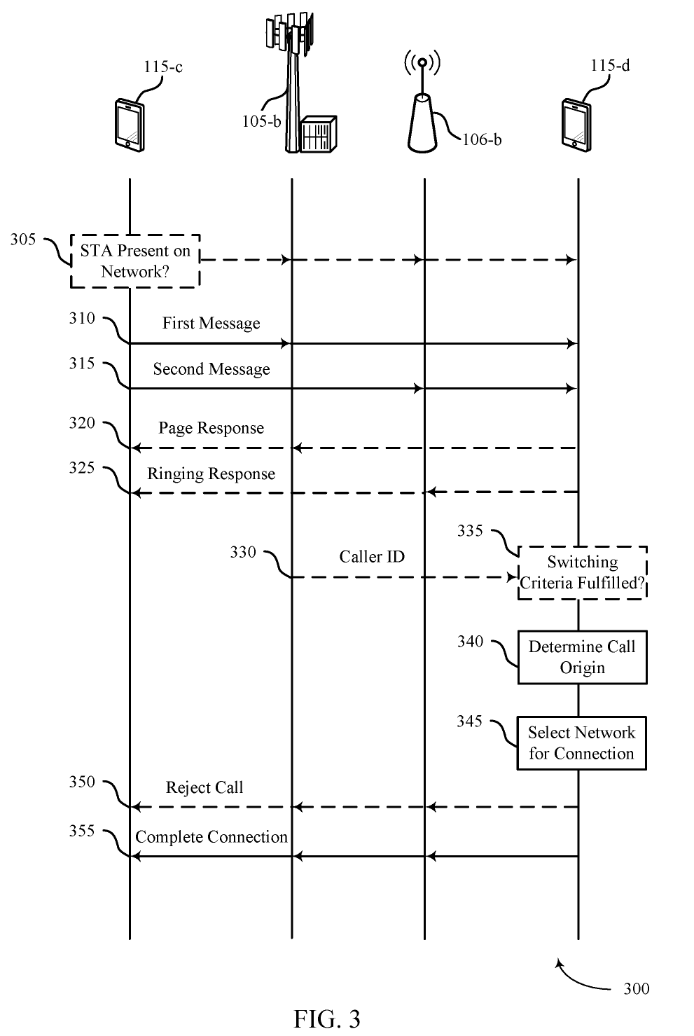

FIG. 3 illustrates an example of a process flow 300 for call fusion in accordance with various aspects of the present disclosure. In some cases, process flow 300 may represent aspects of techniques performed by a UE 115, base station 105, or access point 106 as described with reference to FIGS. 1-2. Process flow 300 may include a transmitting UE 115-c, a base station 105-b, an AP 106-b, and a receiving UE 115-d, which may be examples of the transmitting UE 115-a, the base station 105-a, the AP 106-a, and the receiving UE 115-b of FIG. 2, respectively.

At step 305, the transmitting UE 115-c may determine whether the receiving UE 115-d is present on at least one network. For example, the transmitting UE 115-c may determine that the receiving UE 115-d is present on the second network, or the WLAN. If the receiving UE 115-d is not present on the second network there may be significant delays when attempting to establish a call.

At step 310, the transmitting UE 115-c may transmit a first message. The first message may originate a first call on a first network, which may be a WWAN. The first message may be transmitted to the receiving UE 115-d, or may be transmitted to the base station 105-b and then transmitted to the receiving UE 115-d. For example, the transmitting UE 115-c may transmit an indication to originate a call to the base station 105-b and the base station 105-b may transmit a page message to the receiving UE 115-d. For the purposes of the present disclosure when discussing a first UE transmitting a message to a second UE, it is to be understood that the message may be transmitted from the first UE to the second UE, may be transmitted from the first UE to the base station and a subsequent message (which may be forwarding the same message, or transmitting a related message) transmitted from the base station to the second UE, or may be transmitted from the first UE to the AP and a subsequent message (which may be forwarding the same message, or transmitting a related message) transmitted from the AP to the second UE.

At step 315, the transmitting UE 115-c may transmit a second message. The second message may originate a second call on a second network, which may be a WLAN.

The second message may be transmitted to the receiving UE 115-d, or may be transmitted to the access point 106-b and then transmitted to the receiving UE 115-d. For example, the transmitting UE 115-c may transmit an invite message to the receiving UE 115-d. It should be noted that originating the first call on the first network and originating the second call on the second network may be performed simultaneously, as discussed above. Further, the first call and the second call may be directed to the same user, such as the receiving UE 115-d.

At step 320, the receiving UE 115-d may transmit a page response to the base station 105-b or the transmitting UE 115-c. The page response may be responsive to the first message.

At step 325, the receiving UE 115-d may transmit a ringing response to the AP 106-b or the transmitting UE 115-c. The ringing response may be responsive to the second message.

At step 330, the base station 105-b and/or the AP 106-b may transmit information identifying the transmitting UE 115-c to the receiving UE 115-d. For example, the base station 105-b may transmit a caller identification (ID) of the transmitting UE 115-c to the receiving UE 115-d. In some cases, the access point 106-b may transmit server data identifying the transmitting UE 115-c to the receiving UE 115-d.

At step 335, the receiving UE 115-d may determine that a switching criteria has been fulfilled. For example, the switching criteria may be fulfilled upon reception of identifying information from the base station 105-b and/or the AP 106-b.

At step 340, the receiving UE 115-d may determine that the first call and the second call originate from the same user, or from the same transmitting UE 115-c. In some cases, step 340 is performed only after the switching criteria of step 335 has been fulfilled. Determining that the first call and the second call originate from the same user may include matching a caller ID of the first message with caller information, such as from server data, of the second message.

At step 345, the receiving UE 115-d may select a network to complete a connection for a call. For example, the receiving UE 115-d may select the first network to complete a connection for the first call, or may select the second network to complete a connection for the second call. Selecting a network may be based on at least one of a link latency, a link quality, a user history, a preference (such as a default preference or a user selected preference), a current location of the receiving UE 115-d, or a combination thereof. For example, the receiving UE 115-d may store a history of unreliable WLANs. If the WLAN of the second call is a part of the history of unreliable WLANs, the WWAN may be selected. Similarly, the receiving UE 115-d may recognize unreliable WLANs based on a current location of the receiving UE 115-d. The link latency and/or link quality may be compared to a threshold value, such as a threshold link latency value or threshold link quality value, respectively, when determining if connection quality, such as for the WLAN, is sufficient for performing a call. In some cases, step 345 may be performed by the transmitting UE 115-c. Further, a message indicating the selected network may be exchanged between any or all of the transmitting UE 115-c, the base station 105-b, the AP 106-b, and the receiving UE 115-d.

At step 350, the receiving UE 115-d may reject a call on a network which is not selected for completing the call. For example, if the receiving UE 115-d selects the first network for completing the first call, at step 350 the receiving UE 115-d may reject the second call on the second network. Similarly, if the receiving UE 115-d selects the second network for completing the second call, at step 350 the receiving UE 115-d may reject the first call on the first network.

At step 355, the receiving UE 115-d and/or the base station 105-b or the AP 106-b may complete a connection on a network for a call. Step 355 may be based on the selected network from step 345. For example, if the second network is selected at step 345, then at step 355 the receiving UE 115-d and/or the AP 106-b may complete the connection for the second call using the second network. Similarly, if the first network is selected at step 345, then at step 355 the receiving UE 115-d and/or the base station 105-b may complete the connection for the first call using the first network. Once the connection is completed, the transmitting UE 115-c and the receiving UE 115-d may participate in a call. It should be noted that even though two calls were originated and a number of steps performed, such as any or all of step 305 through step 355, the call establishment delays of process flow 300 should remain similar to, or the same as, call establishment delays associated with performing a single WWAN call. Indeed, any or all of steps 320 through 350 of process flow 300 may be performed between call origination and when the user of the receiving UE 115-d accepts or answers one of the calls. As such, process flow 300 is beneficial in that it provides for an improved network selection for calls, between a number of different networks, without increasing call establishment delays, and thereby negatively affecting the user experience.

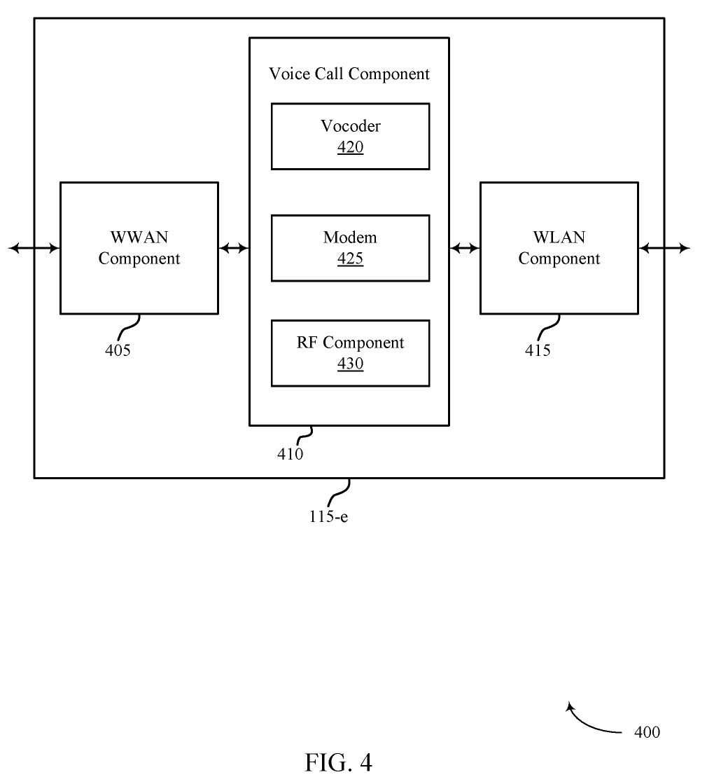

FIG. 4 illustrates a diagram of a device 400 for call fusion in accordance with various aspects of the present disclosure. The device 400 may be a UE 115-e, which may be an example of a UE 115 as described with reference to FIGS. 1-3.

UE 115-e may include a WWAN component 405, a voice call component 410, and a WLAN component 415. Each of these components may communicate, directly or indirectly, with one another (e.g., via at least one bus). Further, voice call component 410 may include a vocoder 420, a modem 425, and a radio frequency (RF) component 430, which all may communicate, directly or indirectly, with one another or with other components of UE 115-e. It should be noted that although referred to as a voice call component, voice call component 410 may be a general component responsible for calls, voice calls, video calls, or other connections between devices. The WWAN component may include transceivers or other devices necessary to communicate over a WWAN. Similarly, the WLAN component may include transceivers or other devices necessary for communicating over a WLAN.

The voice call component 410 may include components used for calls, such as voice calls or video calls. In some cases, some or all of the components of the voice call component 410 may be shared between the WWAN component 405 and the WLAN component 415. By sharing any portion of the voice call component 410, the UE 115-e may save resources, power, and physical space over having separate components for each of the WWAN component and the WLAN component. In some cases, sharing parts of the voice call component 410 between the WWAN component 405 and the WLAN component 415 may require changes at the stack level.

Specifically, the vocoder 420 may be shared between the WWAN component 405 and the WLAN component 415. By sharing the vocoder 420, the UE 115-e may originate a number of calls on multiple networks simultaneously. For example, the UE 115-e may originate a first call on a first network (such as a WWAN) using the WWAN component 405 and the vocoder 420. At the same, or a similar time, the UE 115-e may originate a second call on a second network (such as a WLAN) using the WLAN component 415 and the vocoder 420. The resources of the vocoder 420 may be multiplexed, such as time division multiplexed, frequency division multiplexed, or code division multiplexed, to accommodate simultaneous origination of calls on multiple networks. Further, the modem 425 and/or RF component 430 may be multiplexed, such as time division multiplexed, frequency division multiplexed, or code division multiplexed, to accommodate simultaneous origination of calls on multiple networks. It should be noted that simultaneous use, or sharing, of the voice call components 410 may be used to originate calls, however sharing of the voice call components 410 may cease upon, or before, connection of one of the originated calls.

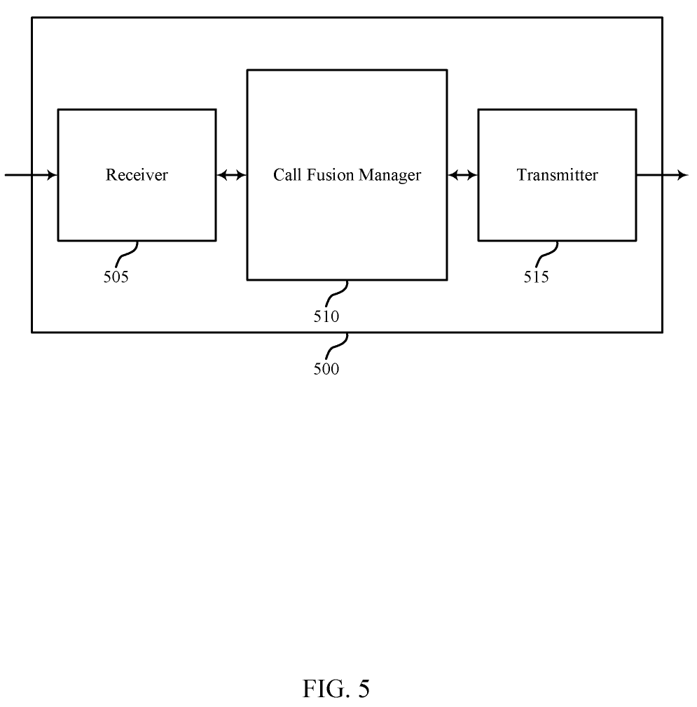

FIG. 5 shows a block diagram of a wireless device 500 that supports call fusion in accordance with various aspects of the present disclosure. Wireless device 500 may be an example of aspects of a UE 115, a base station 105, or an AP 106 described with reference to FIGS. 1-4. Wireless device 500 may include receiver 505, transmitter 515 and call fusion manager 510. Wireless device 500 may also include a processor. Each of these components may be in communication with each other.

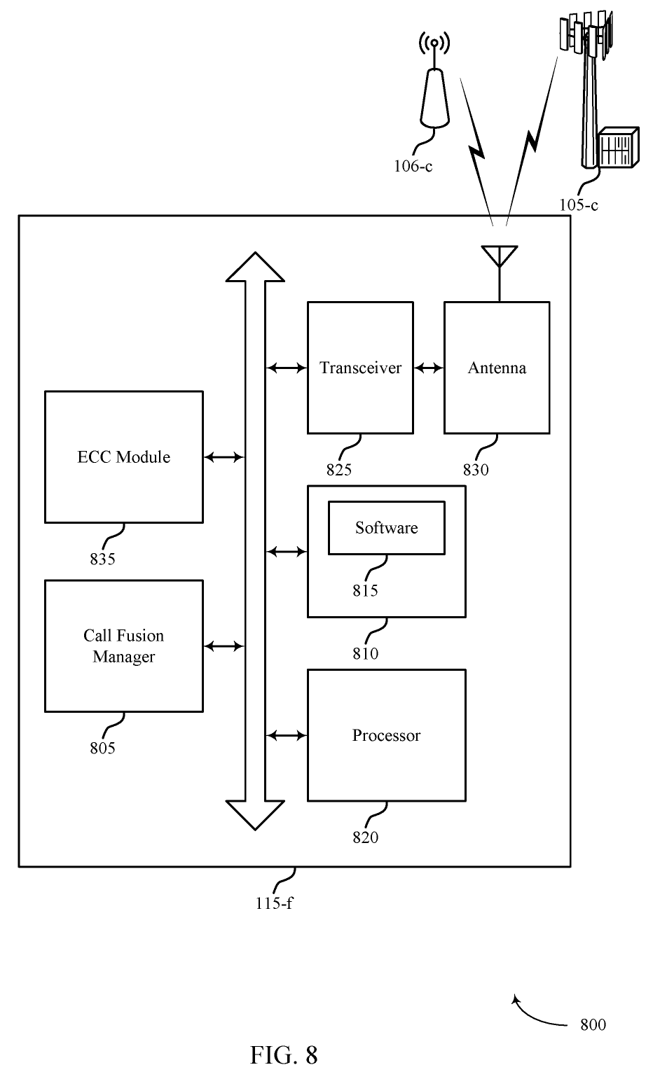

The receiver 505 may receive information such as packets, user data, or control information associated with various information channels (e.g., control channels, data channels, and information related to call fusion, etc.). Information may be passed on to other components of the device. The receiver 505 may be an example of aspects of the transceiver 825 described with reference to FIG. 8. The receiver 505 may be a component of, or may represent aspects of, the WWAN component 405 and/or the WLAN component 415 as described with reference to FIG. 4.

The transmitter 515 may transmit signals received from other components of wireless device 500. In some examples, the transmitter 515 may be collocated with a receiver in a transceiver module. For example, the transmitter 515 may be an example of aspects of the transceiver 825 described with reference to FIG. 8. The transmitter 515 may include a single antenna, or it may include a plurality of antennas. The transmitter 515 may be a component of, or may represent aspects of, the WWAN component 405 and/or the WLAN component 415 as described with reference to FIG. 4.

The call fusion manager 510 may simultaneously initiate a first call and a second call, transmit a first message to originate the first call on a first network, transmit a second message to originate the second call on a second network, and establish a connection for a call on the first network or the second network.

The call fusion manager 510 may also receive a first message to originate a first call on a first network, receive a second message to originate a second call on a second network, determine that the first call and the second call originate from a same user, and select the first network or the second network to complete a connection for a call. The call fusion manager 510 may also be an example of aspects of the call fusion manager 805 described with reference to FIG. 8. The call fusion manager 510 may be a component of, or may represent aspects of, the voice call component 410 as described with reference to FIG. 4.

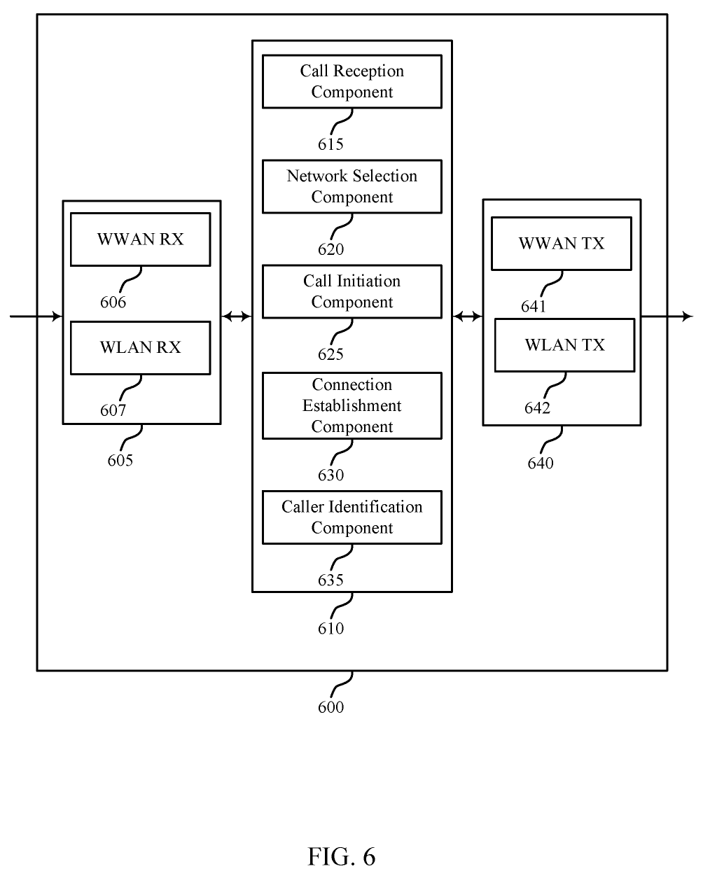

FIG. 6 shows a block diagram of a wireless device 600 that supports call fusion in accordance with various aspects of the present disclosure. Wireless device 600 may be an example of aspects of a wireless device 500 or a UE 115 described with reference to FIGS. 1-5. Wireless device 600 may include receiver 605, call fusion manager 610 and transmitter 640. Wireless device 600 may also include a processor. Each of these components may be in communication with each other.

The receiver 605 may receive information which may be passed on to other components of the device. The receiver 605 may also perform the functions described with reference to the receiver 505 of FIG. 5. The receiver 605 may be an example of aspects of the transceiver 825 described with reference to FIG. 8. Receiver 605 may include WWAN receiver 606 (which may be a component of a WWAN transceiver) and WLAN receiver 607 (which may be a component of a WLAN transceiver).

The call fusion manager 610 may be an example of aspects of call fusion manager 510 described with reference to FIG. 5. The call fusion manager 610 may include call reception component 615, network selection component 620, call initiation component 625, connection establishment component 630 and caller identification component 635. The call fusion manager 610 may be an example of aspects of the call fusion manager 805 described with reference to FIG. 8.

The call reception component 615 may receive a first message to originate a first call on a first network, and receive a second message to originate a second call on a second network. In some cases, the first network is a WWAN and the second network is a WLAN.

The network selection component 620 may select the first network or the second network, such as based on determining that a switching criteria has been fulfilled, select the first network or the second network to complete the connection for the first call or the second call based on the network indicator, and select the first network or the second network to complete a connection for a call.

In some cases, selecting the first network or the second network includes selecting the first network to complete the connection for the first call based on determining that the second network is unreliable based on a current location, a user history, or a combination thereof. In some cases, selecting the first network or the second network includes selecting the second network to complete the connection for the second call based on a link latency, a link quality, or a combination thereof.

The call initiation component 625 may simultaneously initiate a first call and a second call, transmit a first message to originate the first call on a first network, transmit a second message to originate the second call on a second network, transmit first network identification information on the first network, where the first network identification information identifies at least a source of the first call, and transmit second network identification information on the second network, where the second network identification information identifies at least the source of the second call. In some cases, the first call and the second call are initiated simultaneously by a same vocoder. In some cases, the first network and the second network are different networks.

The connection establishment component 630 may establish a connection for a call on the first network or the second network. In some cases, establishing the connection includes receiving a network indicator, where the network indicator indicates a network to use for establishing the connection.

The caller identification component 635 may determine that the first call and the second call originate from a same user. In some cases, determining that the first call and the second call originate from the same user includes matching a caller identification (ID) on the first network with server data relating to the same user from the second network.

The transmitter 640 may transmit signals received from other components of wireless device 600. In some examples, the transmitter 640 may be collocated with a receiver in a transceiver module. For example, the transmitter 640 may be an example of aspects of the transceiver 825 described with reference to FIG. 8. The transmitter 640 may utilize a single antenna, or it may utilize a plurality of antennas. Transmitter 640 may include WWAN transmitter 641 (which may be a component of a WWAN transceiver) and WLAN transmitter 642 (which may be a component of a WLAN transceiver). The WWAN receiver 606 and/or the WWAN transmitter 641 may be a component of, or may represent aspects of, the WWAN component 405 as described with reference to FIG. 4. The WLAN receiver 607 and/or the WLAN transmitter 642 may be a component of, or may represent aspects of, the WLAN component 415 as described with reference to FIG. 4.

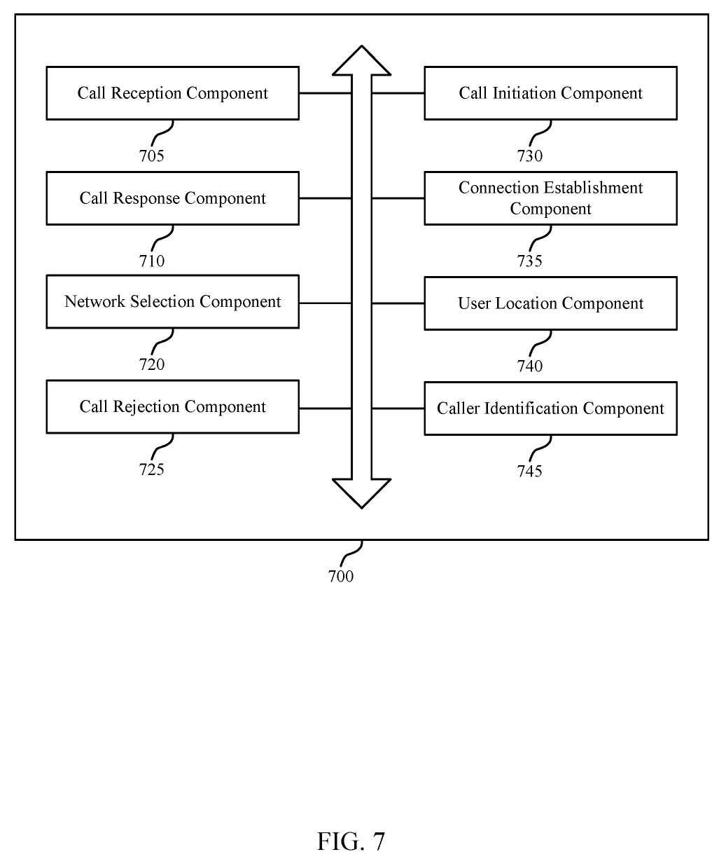

FIG. 7 shows a block diagram of a call fusion manager 700 which may be an example of the corresponding component of wireless device 500 or wireless device 600. That is, call fusion manager 700 may be an example of aspects of call fusion manager 510 or call fusion manager 610 described with reference to FIGS. 5 and 6. The call fusion manager 700 may also be an example of aspects of the call fusion manager 805 described with reference to FIG. 8.

The call fusion manager 700 may include call reception component 705, call response component 710, network selection component 720, call rejection component 725, call initiation component 730, connection establishment component 735, user location component 740 and caller identification component 745. Each of these modules may communicate, directly or indirectly, with one another (e.g., via at least one bus).

The call reception component 705 may receive a first message to originate a first call on a first network, and receive a second message to originate a second call on a second network. In some cases, the first network is a wireless wide area network (WWAN) and the second network is a wireless local area network (WLAN).

The call response component 710 may transmit a page response responsive to the first message, transmit a ringing response responsive to the second message, receive a page response responsive to the first message, and receive a ringing response responsive to the second message.

The network selection component 720 may select the first network or the second network based on determining that a switching criteria has been fulfilled, select the first network or the second network to complete the connection for the first call or the second call based on the network indicator, and select the first network or the second network to complete a connection for a call.

The call rejection component 725 may reject the first call or the second call on the first network or the second network based on selecting the first network or the second network to complete the connection.

The call initiation component 730 may simultaneously initiate a first call and a second call, transmit a first message to originate the first call on a first network, transmit a second message to originate the second call on a second network, transmit first network identification information on the first network, where the first network identification information identifies at least a source of the first call, and transmit second network identification information on the second network, where the second network identification information identifies at least the source of the second call.

The connection establishment component 735 may establish a connection for a call on the first network or the second network. In some cases, establishing the connection includes receiving a network indicator, where the network indicator indicates a network to use for establishing the connection. The user location component 740 may determine that the same user is present on at least one of the first network or the second network.

The caller identification component 745 may determine that the first call and the second call originate from a same user. In some cases, determining that the first call and the second call originate from the same user includes matching a caller identification (ID) on the first network with server data relating to the same user from the second network.

FIG. 8 shows a diagram of a system 800 including a device that supports call fusion in accordance with various aspects of the present disclosure. For example, system 800 may include UE 115-f, which may be an example of a wireless device 500, a wireless device 600, or a UE 115 as described with reference to FIGS. 1-7.

UE 115-f may also include call fusion manager 805, memory 810, processor 820, transceiver 825, antenna 830 and ECC module 835. Each of these modules may communicate, directly or indirectly, with one another (e.g., via at least one bus). The call fusion manager 805 may be an example of a call fusion manager as described with reference to FIGS. 5 through 7.

The memory 810 may include random access memory (RAM) and read only memory (ROM). The memory 810 may store computer-readable, computer-executable software including instructions that, when executed, cause the processor to perform various functions described herein (e.g., call fusion, etc.). In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC), etc.)

The transceiver 825 may communicate bi-directionally, via at least one antenna, wired, or wireless links, with at least one network, as described above. For example, the transceiver 825 may communicate bi-directionally with an AP 106, a base station 105, or a

UE 115. The transceiver 825 may also include a modem to modulate the packets and provide the modulated packets to the antennas for transmission, and to demodulate packets received from the antennas. In some cases, the wireless device may include a single antenna 830. However, in some cases the device may have more than one antenna 830, which may be capable of concurrently transmitting or receiving multiple wireless transmissions. The transceiver 825 may be a component of, or may represent aspects of, the WWAN component 405 and/or the WLAN component 415 as described with reference to FIG. 4. The transceiver 825, the antenna 830, and/or the processor 820 may be a component of, or may represent aspects of, the voice call component 410, the modem 425, the vocoder 420, and/or the RF component 430 as described with reference to FIG. 4.

ECC module 835 may enable ECC operations including operations using variable length TTIs, operations in unlicensed spectrum, and operations using a wide bandwidth as described above with reference to FIG. 1.

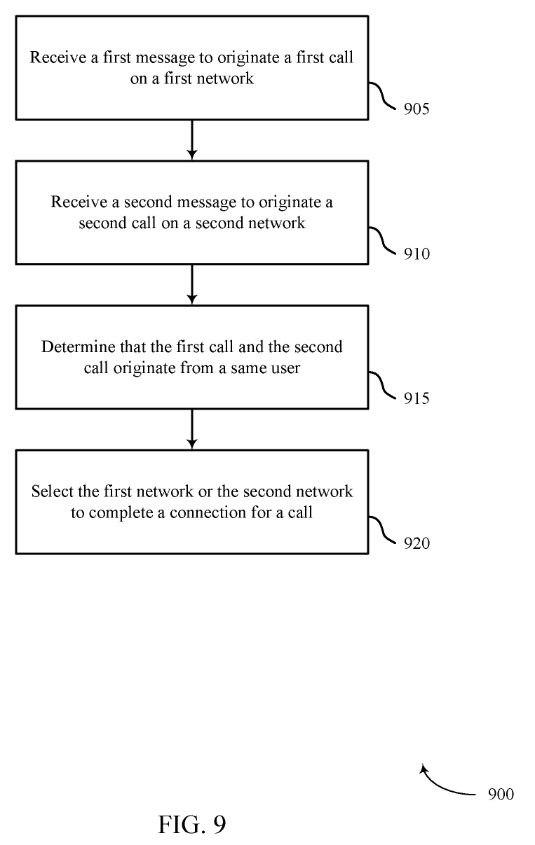

FIG. 9 shows a flowchart illustrating a method 900 for call fusion in accordance with various aspects of the present disclosure. The operations of method 900 may be implemented by a device such as a UE 115 or its components as described with reference to FIGS. 1-8. For example, the operations of method 900 may be performed by the call fusion manager as described herein. In some examples, the UE 115 may execute a set of codes to control the functional elements of the device to perform the functions described below. Additionally or alternatively, the UE 115 may perform aspects of the functions described below using special-purpose hardware.

At block 905, the UE 115 may receive a first message to originate a first call on a first network as described above with reference to FIGS. 2 through 4. In certain examples, the operations of block 905 may be performed by the call reception component as described with reference to FIGS. 6 and 7.

At block 910, the UE 115 may receive a second message to originate a second call on a second network as described above with reference to FIGS. 2 through 4. In certain examples, the operations of block 910 may be performed by the call reception component as described with reference to FIGS. 6 and 7.

At block 915, the UE 115 may determine that the first call and the second call originate from a same user as described above with reference to FIGS. 2 through 4. In certain examples, the operations of block 915 may be performed by the caller identification component as described with reference to FIGS. 6 and 7.

At block 920, the UE 115 may select the first network or the second network to complete a connection for a call as described above with reference to FIGS. 2 through 4. In certain examples, the operations of block 920 may be performed by the network selection component as described with reference to FIGS. 6 and 7.

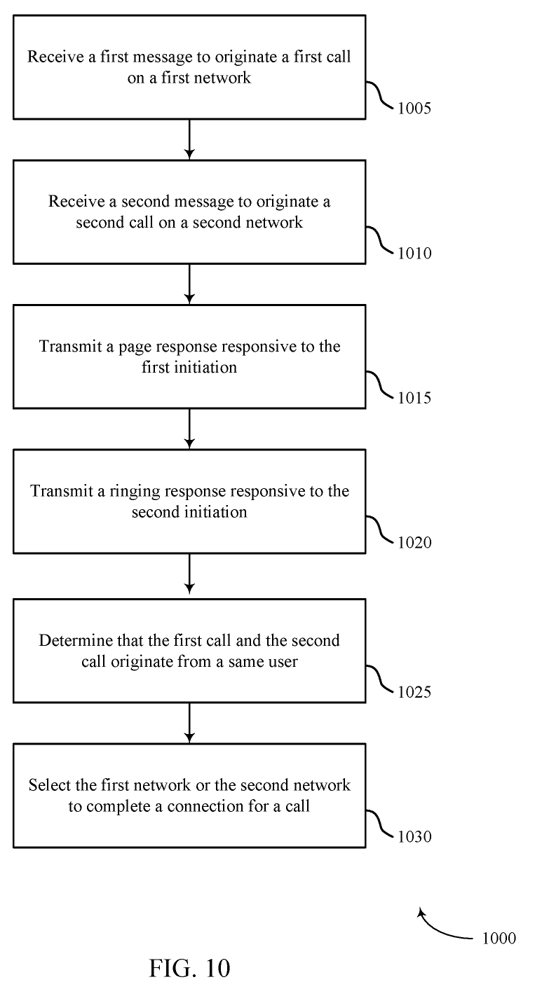

FIG. 10 shows a flowchart illustrating a method 1000 for call fusion in accordance with various aspects of the present disclosure. The operations of method 1000 may be implemented by a device such as a UE 115 or its components as described with reference to FIGS. 1-8. For example, the operations of method 1000 may be performed by the call fusion manager as described herein. In some examples, the UE 115 may execute a set of codes to control the functional elements of the device to perform the functions described below. Additionally or alternatively, the UE 115 may perform aspects the functions described below using special-purpose hardware.

At block 1005, the UE 115 may receive a first message to originate a first call on a first network as described above with reference to FIGS. 2 through 4. In certain examples, the operations of block 1005 may be performed by the call reception component as described with reference to FIGS. 6 and 7.

At block 1010, the UE 115 may receive a second message to originate a second call on a second network as described above with reference to FIGS. 2 through 4. In certain examples, the operations of block 1010 may be performed by the call reception component as described with reference to FIGS. 6 and 7.

At block 1015, the UE 115 may transmit a page response responsive to the first message as described above with reference to FIGS. 2 through 4. In certain examples, the operations of block 1015 may be performed by the call response component as described with reference to FIGS. 6 and 7.

At block 1020, the UE 115 may transmit a ringing response responsive to the second message as described above with reference to FIGS. 2 through 4. In certain examples, the operations of block 1020 may be performed by the call response component as described with reference to FIGS. 6 and 7.

At block 1025, the UE 115 may determine that the first call and the second call originate from a same user as described above with reference to FIGS. 2 through 4. In certain examples, the operations of block 1025 may be performed by the caller identification component as described with reference to FIGS. 6 and 7.

At block 1030, the UE 115 may select the first network or the second network to complete a connection for a call as described above with reference to FIGS. 2 through 4. In certain examples, the operations of block 1030 may be performed by the network selection component as described with reference to FIGS. 6 and 7.

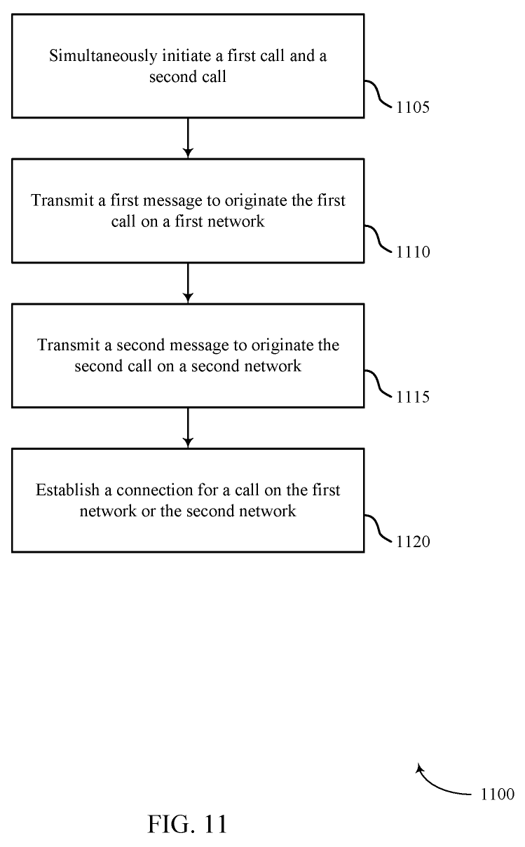

FIG. 11 shows a flowchart illustrating a method 1100 for call fusion in accordance with various aspects of the present disclosure. The operations of method 1100 may be implemented by a device such as a UE 115 or its components as described with reference to FIGS. 1-8. For example, the operations of method 1100 may be performed by the call fusion manager as described herein. In some examples, the UE 115 may execute a set of codes to control the functional elements of the device to perform the functions described below. Additionally or alternatively, the UE 115 may perform aspects the functions described below using special-purpose hardware.

At block 1105, the UE 115 may simultaneously initiate a first call and a second call as described above with reference to FIGS. 2 through 4. In certain examples, the operations of block 1105 may be performed by the call initiation component as described with reference to FIGS. 6 and 7.

At block 1110, the UE 115 may transmit a first message to originate the first call on a first network as described above with reference to FIGS. 2 through 4. In certain examples, the operations of block 1110 may be performed by the call initiation component as described with reference to FIGS. 6 and 7.

At block 1115, the UE 115 may transmit a second message to originate the second call on a second network as described above with reference to FIGS. 2 through 4. In certain examples, the operations of block 1115 may be performed by the call initiation component as described with reference to FIGS. 6 and 7.

At block 1120, the UE 115 may establish a connection for a call on the first network or the second network as described above with reference to FIGS. 2 through 4. In certain examples, the operations of block 1120 may be performed by the connection establishment component as described with reference to FIGS. 6 and 7.

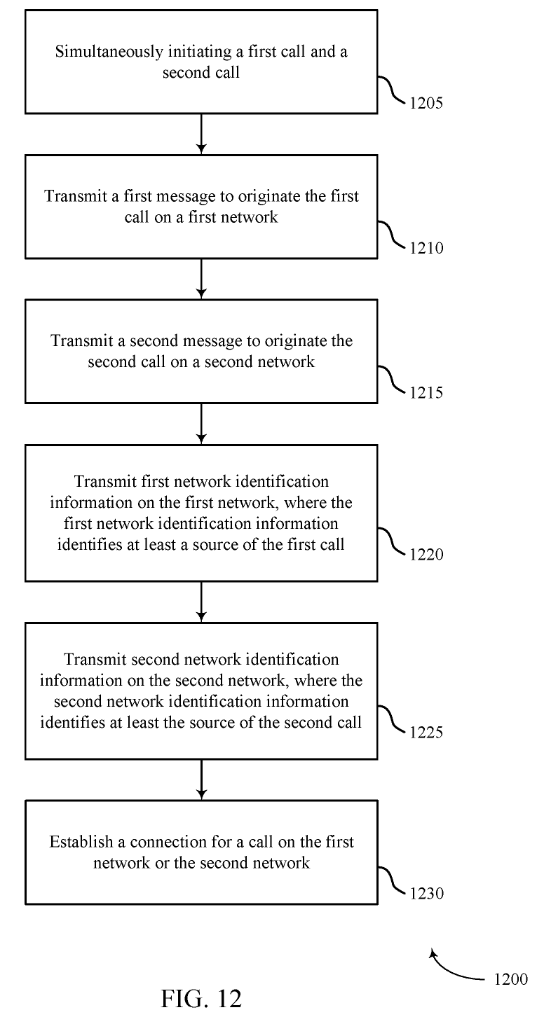

FIG. 12 shows a flowchart illustrating a method 1200 for call fusion in accordance with various aspects of the present disclosure. The operations of method 1200 may be implemented by a device such as a UE 115 or its components as described with reference to FIGS. 1-8. For example, the operations of method 1200 may be performed by the call fusion manager as described herein. In some examples, the UE 115 may execute a set of codes to control the functional elements of the device to perform the functions described below. Additionally or alternatively, the UE 115 may perform aspects the functions described below using special-purpose hardware.

At block 1205, the UE 115 may simultaneously initiate a first call and a second call as described above with reference to FIGS. 2 through 4. In certain examples, the operations of block 1205 may be performed by the call initiation component as described with reference to FIGS. 6 and 7.

At block 1210, the UE 115 may transmit a first message to originate the first call on a first network as described above with reference to FIGS. 2 through 4. In certain examples, the operations of block 1210 may be performed by the call initiation component as described with reference to FIGS. 6 and 7.

At block 1215, the UE 115 may transmit a second message to originate the second call on a second network as described above with reference to FIGS. 2 through 4. In certain examples, the operations of block 1215 may be performed by the call initiation component as described with reference to FIGS. 6 and 7.

At block 1220, the UE 115 may transmit first network identification information on the first network, where the first network identification information identifies at least a source of the first call as described above with reference to FIGS. 2 through 4. In certain examples, the operations of block 1220 may be performed by the call initiation component as described with reference to FIGS. 6 and 7.

At block 1225, the UE 115 may transmit second network identification information on the second network, where the second network identification information identifies at least the source of the second call as described above with reference to FIGS. 2 through 4. In certain examples, the operations of block 1225 may be performed by the call initiation component as described with reference to FIGS. 6 and 7.

At block 1230, the UE 115 may establish a connection for a call on the first network or the second network as described above with reference to FIGS. 2 through 4. In certain examples, the operations of block 1230 may be performed by the connection establishment component as described with reference to FIGS. 6 and 7.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for call fusion.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof If implemented in software executed by a processor, the functions may be stored on or transmitted over as at least one instruction or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical (PHY) locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations).

The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include at least one carrier, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or TDD operation (e.g., using unpaired spectrum resources). Frame structures may be defined for FDD (e.g., frame structure type 1) and TDD (e.g., frame structure type 2).

Thus, aspects of the disclosure may provide for call fusion. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, at least one microprocessor in conjunction with a DSP core, or any other such configuration). Thus, the functions described herein may be performed by at least one other processing unit (or core), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by at least one general or application-specific processor.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
receiving a first message to originate a first call on a first network;
receiving a second message to originate a second call on a second network;
determining that the first call and the second call originate from a same user; and
selecting the first network or the second network to complete a connection for a call.

2. The method of claim 1, wherein selecting the first network or the second network comprises: selecting the second network to complete the connection for the second call based at least in part on a link latency, a link quality, or a combination thereof

3. The method of claim 1, wherein the first network is a wireless wide area network (WWAN) and the second network is a wireless local area network (WLAN).

4. The method of claim 3, further comprising:
transmitting a page response responsive to the first message; and
transmitting a ringing response responsive to the second message.

5. The method of claim 1, wherein determining that the first call and the second call originate from the same user comprises: matching a caller identification (ID) on the first network with server data relating to the same user from the second network.

6. The method of claim 1, further comprising:
selecting the first network or the second network is performed based at least in part on determining that a switching criteria has been fulfilled.

7. The method of claim 1, further comprising:
rejecting the first call or the second call on the first network or the second network based at least in part on selecting the first network or the second network to complete the connection.

8. The method of claim 1, wherein selecting the first network or the second network comprises: selecting the first network to complete the connection for the first call based at least in part on determining that the second network is unreliable based at least in part on a current location, a user history, or a combination thereof.

9. A method of wireless communication comprising:
simultaneously initiating a first call and a second call;
transmitting a first message to originate the first call on a first network;
transmitting a second message to originate the second call on a second network; and
establishing a connection for a call on the first network or the second network.

10. The method of claim 9, wherein the first call and the second call are initiated simultaneously by a same vocoder.

11. The method of claim 9, wherein the first network and the second network are different networks.

12. The method of claim 11, wherein the first network is a wireless wide area network (WWAN) and the second network is a wireless local area network (WLAN).

13. The method of claim 12, further comprising:
receiving a page response responsive to the first message; and
receiving a ringing response responsive to the second message.

14. The method of claim 9, wherein the first message and the second message are transmitted to a same user.

15. The method of claim 14, further comprising:
determining that the same user is present on at least the first network, the second network, or a combination thereof

16. The method of claim 9, further comprising:
transmitting first network identification information on the first network, wherein the first network identification information identifies at least a source of the first call; and
transmitting second network identification information on the second network, wherein the second network identification information identifies at least the source of the second call.

17. The method of claim 9, wherein establishing the connection comprises:
receiving a network indicator, wherein the network indicator indicates a network to use for establishing the connection; and
selecting the first network or the second network to complete the connection for the first call or the second call based at least in part on the network indicator.

18. An apparatus for wireless communication comprising:
a receiver to receive a first message to originate a first call on a first network;
the receiver to receive a second message to originate a second call on a second network;
a caller identification component to determine that the first call and the second call originate from a same user; and
a network selection component to select the first network or the second network to complete a connection for a call.

19. The apparatus of claim 18, wherein the first network is a wireless wide area network (WWAN) and the second network is a wireless local area network (WLAN).

20. The apparatus of claim 18, further comprising:
a call rejection component for rejecting the first call or the second call on the first network or the second network based at least in part on selecting the first network or the second network to complete the connection.
